(19) United States
(12) Patent Application Publication
(10) Pub. No.: US 2024/0202488 A1
(43) Pub. Date: Jun. 20, 2024

(54) VIRTUAL MATTER PLATFORM FOR USE IN LARGE SCALE VIRTUAL ENVIRONMENTS AND ECONOMIC PLATFORM FOR USE THEREWITH

(71) Applicant: SPACEBRAINZ PRIVATE LIMITED, Singapore (SG)

(72) Inventors: Frederick Gertz, Prosperity, SC (US); Warrick Buchanan, Taipei (TW)

(21) Appl. No.: 18/188,566

(22) Filed: Mar. 23, 2023

Related U.S. Application Data
(60) Provisional application No. 63/324,161, filed on Mar. 28, 2022.

(51) Int. Cl. G06N 3/006; A63F 13/69; A63F 13/792; G06Q 20/38; G06Q 40/10

(52) U.S. Cl. CPC G06N 3/006; A63F 13/69; A63F 13/792; G06Q 20/389; G06Q 40/10

(57) ABSTRACT

A virtual matter platform whereby content and an AI mediated creation of the content from bespoke virtual matter can take place wherein the area of artificial life as the virtual environment and the intelligent entities contained within it form an ecosystem. The platform includes an ecosystem for use in the platform wherein the virtual matter residing within a creator wallet has value from being readily transferrable into any number of spaces and while still in the wallet, the virtual matter only exists as an item stored within the ecosystem. The platform facilitates the creation of content, particularly of 3D content as well as methods allowing for the dissemination, re-creation, and leveraging of that content across a variety of user experiences and subsequent derivative content creations. The platform is a gamified virtual environment integrated with an economic platform.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application claims the benefit of U.S. Provisional Patent Application No. 63/324,161, filed on Mar. 28, 2022, which is incorporated by reference herein in its entirety.

### BACKGROUND OF THE INVENTION

### Field of the Invention

The present invention relates to a platform and ecosystem whereby content and the AI mediated creation of the content from bespoke virtual matter can take place and, more specifically, the area of artificial life as the virtual environment and the intelligent entities contained within it form an ecosystem.

### Description of Related Art

Historically, content creation has largely been targeted to a select few members of society. Typically, being a creative content creator takes a significant amount of skill and time and as such the world of creation especially that of creating complex objects (such as video games and 3D art) has largely been left to a small minority of society. Over time, while the market has grown for these complex objects, the market has also become increasingly discerning about quality. This has caused there to be rapid increases in the price of creation of large-scale complex content despite the introduction of off-the-shelf relatively inexpensive equipment and tools. In most fields, content of this nature expands in both reach and price but fundamentally limits its own scale until some sort of technological breakthrough provides ways of either mass producing the content, democratizing access to it, or both. A classic, and perhaps somewhat cliché example would be that of the printing press. Despite increasing appetite for the written word, fundamentally the scale of outreach was limited until the printing press made books and similar vastly more available at a much more economically feasible price to the masses.

There is a need for a platform that not only facilitates the creation of content, particularly of 3D content as well as methods allowing for the dissemination, re-creation, and leveraging of that content across a variety of user experiences and subsequent derivative content creations. With the sudden interest in blockchain technologies and the building of large virtual environments described commonly as ‘metaverse’, there is a need to develop technology around these concepts that incorporates aspects of large virtual environments, Artificial Intelligence (AI), 3D graphics, precision physics simulations, content creation, smart contracts and NFT technology to create a platform that allows for the interactive creation of unique content and the empowerment of content creators to scale their creative offering to a large user group.

Tokenomics is a term that captures a token's economics. It describes the factors that impact a token's use and value, including but not limited to the token's creation and distribution, supply and demand, incentive mechanisms, and token burn schedules. For crypto projects, well-designed tokenomics aids in success.

### SUMMARY OF THE INVENTION

Bearing in mind the problems and deficiencies of the prior art, it is therefore an object of the present invention to provide a platform which facilitates the creation of content, particularly of 3D content as well as methods allowing for the dissemination, re-creation, and leveraging of that content across a variety of user experiences and subsequent derivative content creations.

Still other objects and advantages of the invention will in part be obvious and will in part be apparent from the specification.

The above and other objects, which will be apparent to those skilled in the art, are achieved in the present invention which is directed to a virtual matter platform whereby content and an AI mediated creation of the content from bespoke virtual matter can take place wherein the area of artificial life as the virtual environment and the intelligent entities contained within it form an ecosystem. The platform includes an ecosystem for use in the platform wherein the virtual matter has value from being readily transferrable into any number of spaces existing as an item stored within the ecosystem. In one embodiment of the platform the virtual matter may reside in a creator wallet. The platform facilitates the creation of content, particularly of 3D content as well as methods allowing for the dissemination, re-creation, and leveraging of that content across a variety of user experiences and subsequent derivative content creations. The platform is a gamified virtual environment integrated with an economic platform. The platform allows users to generate and create 3D content which are accomplished by robust and broad simulations. The majority of gameplay interactions are mediated by the virtual matter wherein the virtual matter makes up Spaces and Creatures as a fundamental building block. The platform may encompass a universe of unique ‘Spaces’ each with its own qualities, one of which being its definition of how to process the properties of the virtual matter contained within the universe. Users may create or add to a space by inserting the virtual matter into the space. The virtual matter may be used to construct artificial life components within the spaces that inhabit and interact with them. The platform may include a progression mechanic having the ability to unlock an item or item feature through gameplay elements wherein the gameplay mechanic can be transferred with the item or item feature. Guardians may control dimensions and the Guardians aim to collect economic value by applying an overall tax to the dimensions and gaining a portion of an activity within the platform. The guardians may create specific lock-in/lock-out features of the dimension, describing the conditions in which a user can move spaces out of their dimension. A guardian NFT may allow for a guardian to burn IdolNFTs, the burnt IdolNFTs used to create Cosmic Powers. In an economic model for use in the platform, a user can stake directly into a guardian staking pool, the guardian staking pool applying a generated stake to the entire dimensions. The term staking is not necessarily used as it is in the conventional sense that it is used in industry, but can also mean that a user can essentially use in-game resources to purchase a subscription, this subscription would grant them either access or in-game items or some combination or the two. The platform may use a method for creating virtual items using the platform with a virtual environment using direct manipulation of virtual matter via a digital avatar controlled by a user. The platform may include a method for transfer of digital matter using the platform of claim 1 that has been registered within a distributed ledger between different simulated environments. The platform may include a method for allowing members of a specified class or multiple classes within the structure of the simulated environment to stake materials (including but not limited to time, computing power, fiat currency, virtual matter, NFT's, tokens, objects created with virtual matter or digital currency etc.) into larger pools and deriving value from those pools that can be applied into the digital platform and the virtual environments contained within

The platform may include a method for the creation of advanced structures via layering of different types of materials to create underlying structures that can scaffold overlying structures utilizing a virtual material.

Another aspect of the present invention is directed to a method for tracking on a distributed ledger system the input of creators and suppliers of materials for creation of digital NFT Items so that royalty based upon the prior mentioned previous agreements can be paid out accordingly during the sale of the NFT.

Another aspect of the present invention is directed to A distributed ledger that containing the steps of a simulation, assigning rights to individuals based on their contribution to the simulation whether through simulation efforts, manipulation efforts, or editing efforts and stores steps so as to be recalled later, also allowing for dispersion of value to appropriate stakeholders based on their contribution.

Another aspect of the present invention is directed to a method for using a digital platform whereby users create digital items through interaction with a virtual environment and the simulation of elements within the virtual environment.

Another aspect of the present invention is directed to a method for simulating large scale digital virtual environments comprised of digital matter elements which contain a multitude of virtual properties including but not limited to physical, kinetic, aesthetic and intelligent.

Another aspect of the present invention is directed to a method for creating virtual items with a virtual environment using direct manipulation of virtual matter via a digital avatar controlled by the user.

Another aspect of the present invention is directed to a method for the creating virtual items via the control of conditions within a large virtual environment encompassing the simulation of individual elements within the environment.

Another aspect of the present invention is directed to a method for creating virtual items via the control of intelligent (AI, RNN, etc.) agents that inhabit the environment and manipulate virtual matter via a plurality of different methods of directing the reward function of the intelligent agent.

Another aspect of the present invention is directed to a method for storing the results of the simulation, including the steps of the simulation into a distributed ledger (i.e., blockchain) that can then be stored in unique entities such as a NFT

Another aspect of the present invention is directed to a method for sharing the simulation steps necessary to create the NFT with other users allowing for copying and manipulation of steps to create new items within the virtual environment

Another aspect of the present invention is directed to a method for distributing the simulation across a platform of simulating entities (i.e., using different CPU and GPU time across a plurality of hosts to perform the simulation)

Another aspect of the present invention is directed to a method for representing the value of the simulation effort and thus creating incentive for a plurality of hosts to provide computing time/effort for simulation of entities and environments within the platform.

Another aspect of the present invention is directed to a method for creating an NFT that is fundamentally frangible and fractional so that sub-items can be created from parts of the whole NFT

Another aspect of the present invention is directed to a method for tracking on a distributed ledger system the input of both creators and suppliers of materials for the creation of digital NFT's Items so that royalty based upon the prior mentioned previous agreements can be paid out accordingly during the sale of the NFT.

Another aspect of the present invention is directed to a method of governance that entails using NFT's to assign different rights within a simulated environment ecosystem

Another aspect of the present invention is directed to a method for transfer of digital matter that has been registered within a distributed ledger between different simulated environments.

Another aspect of the present invention is directed to a method for allowing members of a specified class or multiple classes within the structure of the simulated environment to stake materials (including but not limited to time, computing power, fiat currency, virtual matter, NFT's, tokens, objects created with virtual matter or digital currency etc.) into larger pools and deriving value from those pools that can be applied into the digital platform and the virtual environments contained within

Another aspect of the present invention is directed to a method for providing 3D virtual elements properties by which they can evolved and simulated via cellular mathematics rules.

Another aspect of the present invention is directed to methods for the creation of advanced structures via layering of different types of materials to create underlying structures that can scaffold overlying structures utilizing a virtual material.

Another aspect of the present invention is directed to a method for allowing for a digital matter to perform simple switching of other parameters and thus be utilized in the creation of complex and intelligent systems within the virtual environment.

Another aspect of the present invention is directed to a method for the creation of governance NFT items that allow for control of resources both within and between virtual environments contained within a digital and/or distributed platform

Another aspect of the present invention is directed to a method for the creation of governance NFT items that allow for the control of properties within a virtual environment as well as effecting the fundamental aspects of the digital materials contained within that environment.

Another aspect of the present invention is directed to a method for creating an environment containing material that can be arranged, simulated, guided simulated, or evolved in such a way as to produce shapes which can be shared with others. In one embodiment a person could evolve content that could be used for desktop wallpapers, or similar art type content that can be shared with a plurality of individuals.

Another aspect of the present invention is directed to a distributed ledger (or a pointer to a repository there of) that contains the steps of a simulation, assigning rights to individuals based on their contribution to the simulation whether through simulation efforts, manipulation efforts, or editing efforts and stores all of these steps so as to be recalled later, also allowing for dispersion of value to appropriate stakeholders based on their contribution. This aspect of the invention could be embodied by simulations of virtual matter though it is not necessarily limited to just simulations of virtual matter.

Another aspect of the present invention is directed to a gameplay mechanic describing the use of a transferrable progression style ranking between different games/environment/Space.

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a Tokenomics diagram.

FIG. 2 is a staking pools diagram.

FIG. 3 is a diagram showing how users own a range of the simulation, for which royalties for their contribution can be tracked and stored within the ledger.

FIG. 4 is a schematic of the Tokenomics diagram shown in FIG. 1.

FIG. 5 is a schematic diagram of the staking pools diagram shown in FIG. 2.

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Herein is described aspects of the present invention including features of “Virtual Material Science” and a business/technology plan that combines the use of Virtual Matter with the economics of a technology platform that relies on this material. The feature of generating immersive 3D environment built on fundamental sub-components that are inherently 3D objects themselves and contain multiple properties stored within each fundamental element allows for powerful descriptions of each elements properties allowing for a bespoke and custom physics and facilitating a virtual environment that serves as a robust simulation platform that generates elements from the simulation of the complex interactions of these sub-components, named above as Virtual Materials and their properties as Virtual Material Science. These complex interactions are capable of being mediated by AI entities that are made of and inhabit the Platform and allow for large scale interactions with the virtual environment.

The following terms are defined:
Virtual Matter (VM)—Matter comprising the universe of the Platform. Fundamental 3D elements with physical and intelligent properties described within the unit.
Virtual Material Science (VMS)—The dynamics and interactions of Virtual Matter (VM) within simulation environments.
Token Thermodynamics—Name describing the flow of tokens throughout the platform environment from creation of VM to Creators and to players within the platform.
Non-Fungible Token (NFT)—is a non-interchangeable unit of data stored on a blockchain, a form of digital ledger, which can be sold and traded.
ItemNFT—An Item created (or minted) in a Space from the VM contained within the Space. One embodiment but not the only one described here-in is that ItemNFT's are created by binding the correct proportion of VM types to an IBP-NFT.
Item Blueprint NFT (IBP-NFT)—The NFT containing the simulation steps and proportions of VM types necessary to recreate the NFT.
IdeaNFT—IBP-NFT is sometimes referred to as an IdeaNFT.
IdolNFT—An NFT that allows for the transfer of value from a Space back to a Guardian and/or Staking Pool.
Guardian—A person who control a Guardian NFT and thus has the ability to create Cosmic Power and assign it to a Creator Wallet.
Cosmic Power—An amount of virtual substance that can be given to a Creator allowing them to mint nor VM in the proportion determined appropriate by the Platform and Platforms controllers. Cosmic Powers are essentially containers of VM.
Simulation First Design—The paradigm by which the Platform was built, where-in the platform was designed to allow for massive simulations as its primary means for producing value within and from the platform.

A Virtual World platform is a gamified virtual environment closely tied with an economic platform. This world is constructed via the use of proprietary 3D game/physics engine technology from fundamental 3D elements. These elements we refer to (and describe in greater detail below) as Virtual Matter (VM) and the interaction within the Virtual World (Spaces) between elements of Virtual Matter we describe as Virtual Material Science (VMS). Each individual element comprises both visual and physical properties that detail how it interacts within the Virtual World. Users/players within the Virtual World can manipulate the Virtual Matter through bespoke controls and a robust toolset provided by the Platform. Inhabiting the game are also intelligent creatures which have the capability to manipulate matter they have the ability to communicate with each other and even combine/breed to form new unique intelligent entities, these entities serve to make up the creatures and fauna of the Virtual World. Players through a variety of gameplay mechanics are capable of manipulating matter within Virtual Worlds, here-in called Spaces. By manipulating VM players can produce 3D content. This content can have any number of physical or intelligent properties and can even form new creatures/fauna if desired. Users interact with creatures teaching them how to perform tasks to their desire and thus eventually training creatures to perform appropriate tasks within their environments. Users of the Platform derive value from this experience in a variety of ways. First the items they form can be used within a Space to perform a variety of functions based on its design, aesthetic and of course the different combinations of fundamental VM units used to construct it. This item can be minted (see details below) as a unique item NFT (ItemNFT) and then be used within a space. The method for making a unique item can be stored as an Item Blue Print-NFT (IBP-NFT) allowing for the item to be re-created in other Spaces by users who hold the IBP-NFT.

### Simulation First Design

One innovation of the Platform is its holistic Simulation First Design paradigm. The goal of the platform is to allow users to generate and create 3D content which are accomplished by robust and broad simulations. Several games have already explored areas of automated and user led content production and the field of procedural generation has advanced in recent years, but on a whole, these innovations typically lead to ‘broad but not deep’ content. One aspect missing from much automatically generated content is its lack of a history as it were, items rarely show effects of aging or multiple interactions with their environment which always results in them feeling unnatural even in the context of their gameplay environment. To overcome this, all objects require a degree of history, with rich and deep interactions evolving from natural holistic growth. To accomplish this the platform leverages an advanced simulation method or algorithm that allows not just for the generation of content and creatures, but for those items to interact with each other on a massive scale. Items produced within the context of the Platform grow in the platform, interacting with other item, perhaps picking up damage and scarring, or learning new elements, or wrapping around an adjacent element that later withers away only being remembered by the encompassing element now. Items live and die within this space and as such have a history and context from it. To do this the Platform has components its Virtual Matter and Creatures to create and simulate large scale environments and its NFT components to allow for the sharing of items/creatures created as well as the storing of both actual items and how to recreate these items encompassing all the necessary simulation steps to allow for the items to be remade. We describe the innovations in greater detail below.

An item that is all or a subset of a simulation can be represented as a Simulation NFT. A simulation NFT represents the respective range of simulation steps needed to recreate the specific item. As simulations may branch into many new simulations, Simulation NFTs may represent a range of simulation steps across a consecutive path through branches of such forked simulations. Item Blueprint NFTs are a Simulation NFT.

What is Virtual Matter—One of the aspects of the platform is the utilization of Virtual Matter (VM). The majority of gameplay interactions will be mediated in some form by VM. The VM makes up the Spaces and Creatures as its fundamental building block and is a crucial innovation.

VM is a digital representation of a 3D entity that can have a variety of physical, aesthetic, and intelligent features, all stored within the element.

### Properties of Virtual Matter

VM, like real material is not wholly defined by its innate properties but is largely governed within the real-world by them. VM can have a variety of properties, including physical and intelligent described below, and furthermore these properties are mediated by the Space in which the VM is contained.

### Relation to Environment/Spaces

It should be noted that one aspect of the innovation of the Virtual Material Science (VMS) it that its properties are closely tied to the Spaces contained within in. The platform encompasses a universe of unique ‘Spaces’ each with its own qualities, one of which being its definition of how to process the properties of the VM contained within the universe. When a Space is created it has a certain amount of native VM of different properties and over time can have VM added to the environment through a variety of mechanisms described here-in. The VM contained in the Space or added will at the elemental level have its properties defined. However, any of these properties can be modified, enhanced, or canceled by the definition of the Space. For example, one Space may have a custom physics that makes all matter within that Space more flexible, essentially an elastic world. All VM added to that Space will therefore then have its definition of rigidity modified and therefore be less rigid in its interactions with other VM and Creatures. As such the Space acts similar to a video codec that determines how to encode and decode information based on the properties stored within the VM and the directions of ItemNFT's and IBP-NFT's.

This concept of dynamic VMS defined by the rules of the Space allows for a multitude of different experiences to be created even from the same IBP-NFT transferred into a Space. As any creations from one space transferred to another will have different interactions based on the new rules of the universe they now are encompassed by. This element is a unique gameplay feature to the Platform and further serves to enhance the experience for users and create exciting, dynamic interactions even from a single IBP-NFT, as players explore how it interacts with elements across a variety of Spaces.

### Physics of Virtual Matter

The physics of virtual matter relative to the Space it occupies. Each VM has some description of its physical properties, which define how it interacts with the items around it, whether that be the kinetics (which could or could not encompass properties such as weight, density, rigidness, gravity) as well as aesthetic properties (which could include but is not limited to properties such as color, reflectivity, specular reflection, spectroscopy etc.). Items constructed of VM thus are not projections or other representations of 3D objects as with many other physics/3D graphics engines. Within the Platform every items physics is defined by the collection of VM making up that item. Spaces define the physics of the matter. For example, physical kinetics around elastic collisions would be defined by denoting the specific collision rule and would, in this space, be done via a spring/mass model and collision detection by a bounding volume hierarchy.

### Non-Physical Properties/Intelligent Properties

It should be noted that some of the properties of VM can be non-physical in nature. For example, base units may have properties that are inherently such as those that make up elements of Cellular Automata. In Cellular Automata an elements evolution is defined by internal properties that describe how it reacts based on the context of the items immediately adjacent or in proximity to the unit. This type of Cellular interaction can give rise to complex arrangements of cellular entities as they evolve and is an example of a property that can be contained within the definition of an element of VM. As such evolving VM elements may contain properties that describe their evolution, as well as how their evolution is affected by elements in their proximity. These types of instruction may lead to much of the complex or emergent behavior that one might expect from a large scale 3-D simulation of complex environments and is a one aspect of the innovation within the Platform as Cellular procedural generation techniques have only been applied to simple game systems.

Elements of VM may also contain properties, including some basic intelligence properties. In this case we define basic intelligence properties as the ability to perform specific reactions to stimulus. In some cases this property may define itself as the ability to allow certain VM elements to flow through it (thus providing context for some Space's to have power such as electricity or ‘magic’). In other context this intelligent behavior simply be absence of presence of flow depending on context or input from adjacent elements. Some aspects of this intelligent matter may be represented in other games, but not at the fundamental level. This simple kind of logic however would allow for universal computation and representation of algorithms. In this way groups of some VM may be able to create simple and/or complex calculations. Simple logic gates can be constructed utilizing this ‘flow’ like property contained within the VM definition, allowing for a variety of simple/complex/intelligent interactions to be capable within the context of the VM of some Spaces.

Use of Virtual Matter and Interaction with Creatures

### Description of AI-NFT Entities

One component of the platform is that VM can be used to construct artificial life components within the Spaces that inhabit and interact with them. Creatures are essentially simulations that have a structure allowing for movement and interaction as well as some level of intelligence. Intelligence from a practical standpoint is used by relaying points of the simulations for the creature with an intelligent system which could be realized in several iterations, including but not limited to a neural network of various forms or a genetic algorithm. These intelligent entities are capable of learning either from deterministic rule sets provided via the platform or from player manipulated reward functions that would allow the player to manipulate the reward function as a form of training for the creatures.

### Building Via Virtual Matter

In both the creation process as well as the user experience is the toolset that builds out for the creation process. Users will have a variety of different intertwined methods for creating objects within the Platform. From a low-level users can directly manipulate characters from their avatar. Users will be able in a way to directly manipulate the digital matter, as such they actually become an entity within a sort or localized real time simulation. By combining different elements of VM they will be able to build an incredible variety of objects, simulated artifacts, and creatures. Direct manipulation of objects is of course not the only method. Players will be able to move out of the direct view and into a more ‘god-like’ role. In this method they can over see a great deal of the interactions taking place in the game, with views of a large amount of the Space and the inhabitants of the Space. In this view the player will be able to manipulate the simulation that is evolving the VM through the use of tools that will provide a more macroscopic influence to the environment. For example, the ability to build large scale geographic features within the Space can be carried out by the manipulation of weather like patterns. Influence the fauna and creatures through reward like input that effect their own algorithmic reward tendencies will be another method to influence the environment. This god-like view allows for the player to have influence over a scale unlike that seen within other games and also allows for the formations of a huge amount more entities within the Space, as the player is not responsible for the direct control of any singular entity, instead allowing influences on the simulation to carry out that work.

Sharing of Content Built with VM

Described in greater detail below the Platform allows for the sharing of digital items created within the Spaces. Items created within a Space can be exchanged with other players also located within the Space. As described below however, player's cannot move VM between Spaces and as such items in what Space cannot be directly transferred to another Space. However, each item which will be stored as an NFT will also contain an Item Blue Print NFT (IBP-NFT) which can be stored with users in other Spaces. See more details below in the Tokenomics section.

An interesting mechanic that is both innovative and adds additional gameplay elements is a process for creating transferrable progression style mechanics through the transfer of an NFT. In this embodiment we describe a progression mechanic, which is essentially the ability to unlock an item or item features through gameplay elements. While the progression style mechanic exists in other prior art, the innovation is that this gameplay, and the gameplay mechanic can be transferred with the item. As such when a person transfers an item within the Platform they in theory can if desired transfer its mechanic. Meaning that a player could purchase the item, giving them the right to hold it, but they would not be able to use the item, or some aspect of the item's properties until they have fulfilled tasks within a Space as defined by the progression mechanic. This progression mechanic could also be used to trigger a continued/continuous flow of value from the purchaser of the item to the item's creators, one could imagine a mechanic in which essentially a rental style use of items was created. In such a system users would have to continuously perform and win at a gameplay element or pay a fee to continue to unlock the features of the item. This is just one embodiment of the described gameplay mechanic and one could imagine and almost infinite plurality of mechanics that could be utilized. As per other descriptions this progression mechanic would be subject to the rules of the Space in which it is deployed. Another embodiment of the mechanic applies to the transfer of items between Spaces which have some style of progressive ranking. The transfer of the item from one Space to another does not entitle the holder to the rank necessarily but can be used in partial fulfillment. To give some gameplay analogy, a person in one Space may be a level 10 (or any other ranking) character which entitles them to certain privileges within that Space. That level or gameplay class may require both the completion of a variety of gameplay elements as well as needing to acquire certain item(s). If the player transfers the unbound ItemNFT into another Space, they will not necessarily need to complete the tasks of acquiring the item to gain a similar ranking or gameplay class, but they would still need to fulfill the gameplay mechanic that is necessary within that Space as well as any gameplay mechanics necessary to acquire the VM to bind to the item for its binding and creation within the Space.

### Micro-Spaces and Personal Development

The ecosystem can also exist at a smaller scale then some of the areas described herein. A Space could in fact embody a very small are such as a single person or Creators desktop environment. In such an environment they would have a small amount of Virtual Matter to utilize in the simulation of a variety of different shapes and forms. Within this personal Space users could evolve different NFT items and share the IBP-NFT with users on the Platform. One embodiment of this technology could be used for the evolution of images such as those used within a PC desktop environment. In this embodiment user would be able to evolve a variety of different NFT items that could be used to form computer wallpapers, both static wallpapers which could be shared with followers or potential buyers, as well as dynamic wallpapers which could be shared or streamed to other followers/patron/buyers of that particular creator. The creator would be able to evolve and interact with the wallpaper much like we describe in other areas of this document. Evolving and occasionally directing the evolution of the simulation, clicking into the Space, or Desktop environment changing the view and returning to their normal Desktop view all seamlessly allowing for the creation of new NFT entities. These items could be shared within the marketplace, or they could even be shared through typical file sharing protocols/standards/platforms depending on the embodiment. In one embodiment users could form portals with other participants where these environments would allow people accessing the portal to enter another's Space or to send some aspects of the items (possibly including the items themselves) through these ‘desktop’ Portals.

### Organization of SB Spaces

### Initialization of Spaces

Virtual Matter within the Platform is represented as an NFT or as a fungible token and resides in two areas within a platform. These two areas are within a Space or within a creator's wallet where it can be held prior to being placed within a Space. Once VM is applied to Space it can only reside within that space and can no longer be directly transferred out of the Space.

From a physical setup, Virtual Matter that is residing within a Creator Wallet is valuable because it is readily transferrable into any number of Spaces and because while still in a wallet the Virtual Matter only exists as an item stored within the blockchain ecosystem. Once Virtual Matter is applied to a Space it is locked within the Space and cannot be directly transferred out. Also, once this matter is added to the Space it becomes a part of the Space's simulation, meaning that real world resources must be required to maintain it. As more matter is added to a Space the Space will have increasingly large amounts of real-world computational requirements and as such will require real-world resources to maintain the matter within the Space. The advantage of placing matter into the Space is that once added to Space the VM can be manipulated, and players are free to create from the VM to make ItemsNFT's and IBP-NFT's. So, a Space is initialized when a Creator moves VM from their wallet into a Space for the first time. At this time the Space NFT is initialized and will become a ledger of the all the simulation steps being performed within the Space. This allows for the Space NFT and blockchain to act as a sort of cache to allow for the recreation of simulation steps later.

### Governance of Spaces

In the platform's value chain, there are two economic models under consideration, one is a model where people can stake directly into a Guardian Staking Pool which then applies that stake to the entire dimensions (a dimension is a collection of spaces governed by a guardian, a guardian is someone who holds a Guardian NFT). For the description below it should be clear that the present invention is not limited to the specific models described herein and may in the future decide to alter or combine aspects of the models with each other. The technology can be leveraged across a variety of different business and economic process and present how this technology offers business/economic activity within the platform, which is of course facilitated by the innovations described here-in.

### Governance of Spaces and Guardians—Guardian Dimension Staking Model

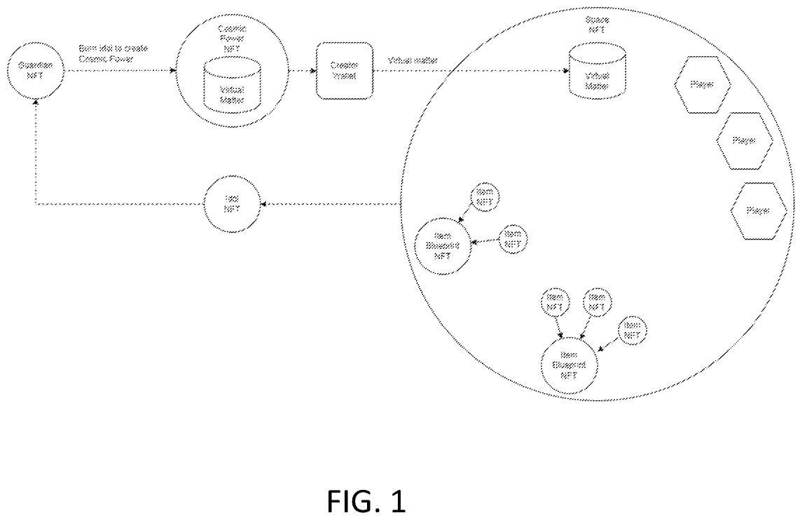

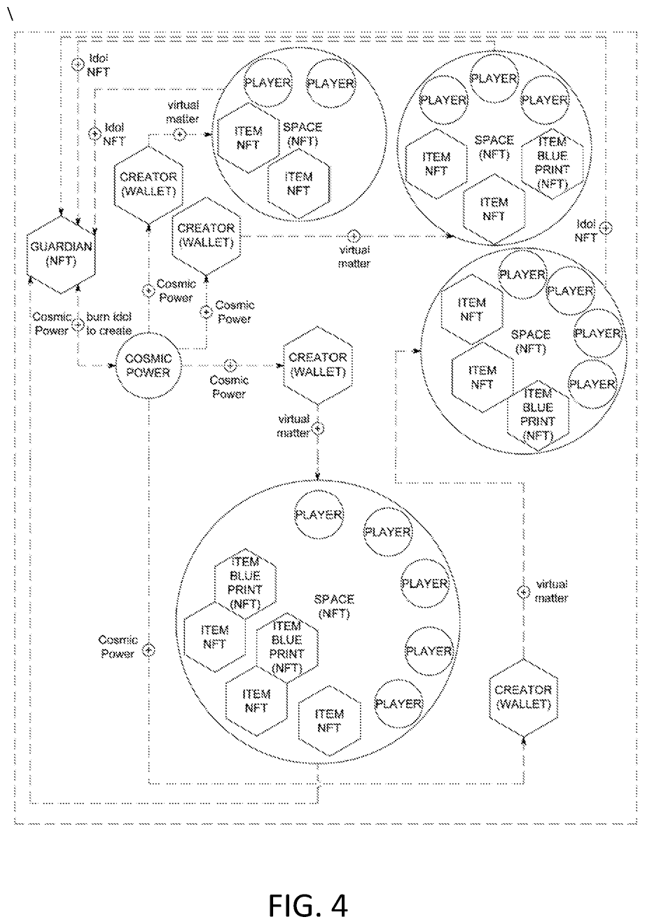

Creators can create or add to a Space by inserting VM into the Space. The process is viewable in FIGS. 1 and 4. Creators choose which Spaces to support and grow via this process or method. Guardians act as curators of the Platform. Platform users holding a Guardian NFT have the ability to create a Guardian Wallet. The holder of a Guardian NFT can use their Guardian Wallet to accept and hold IdolNFT's. An IdolNFT is created when either a user within a Space destroys VM or when an Item Blue Print NFT or ItemNFT is sold on the platform Market. When VM is destroyed, the destroyed VM goes directly into an IdolNFT that can then be sent to the corresponding Guardian Wallet. When items are created in a Space their NFT has two parts. The first part is the actual digital item that can be interacted with and manipulated in the space. The second part is an Item Blue Print NFT (IBP-NFT), which describes the simulation steps, necessary types, structure and morphology (as defined by their physical properties) of VM that are required to recreate the ItemNFT. The simulations steps are stored in or addressed by a blockchain that tracks the steps taken and in the event of a collaborative creation process who is responsible for each step. As such the NFT and corresponding blockchain (or distributed/centralized ledger/repository of any format an embodiment could include, but is not limited, to a pointer or indirect link to the location where the information is stored) represent a cache of the simulation of sorts allowing for recreation of certain simulation steps. This is true for all the NFT's based on simulation results (including Space NFT's, ItemNFT's and IBP-NFT's) that they represent the necessary steps of a simulation and as such users can access the simulation and even edit specific steps, where in such a case the distributed ledger would record the edit step and associated metadata, as a step within the simulation. An item that is all or a subset of a simulation can be represented as a Simulation NFT. A simulation NFT represents the respective range of simulation steps needed to recreate the specific item. As simulations may branch into many new simulations, Simulation NFTs may represent a range of simulation steps across a consecutive path through branches of such forked simulations. Item Blueprint NFTs are a Simulation NFT.

ItemNFT's that have been bound to VM are non-transferrable and are created from the material within the Space and are thus (as described above) trapped within the Space. An ItemNFT is created when an IBP-NFT is bound to an amount of VM which contains VM with the correct properties and in the correct proportions as described within the IBP-NFT. There are two states of ItemNFT's which should be highlighted at this point, those bound to VM and those unbound. An ItemNFT, which is based on an IBP-NFT, has no VM, only descriptions on how to construct it with the appropriate materials. An IBP-NFT could be used to generate multiple ItemNFT's with different properties based on different properties of the underlying VM. One could imagine the IBP-NFT (sometimes referred to as an IdeaNFT), for a sword could produce two unbound ItemNFT's and for the sake of analogy we will use as examples real materials, one made of wood and another made of metal. Users can trade the unbound ItemNFT's and then insert them into a Space where they will be created with the correct VM present in that Space, but ONCE BOUND to the VM they are locked into the Space until unbound. When an ItemNFT is unbound from a Space it leaves its VM behind in that Space. Also, as well as unbound ItemNFT's an IBP-NFT is transferrable via the Platform marketplace.

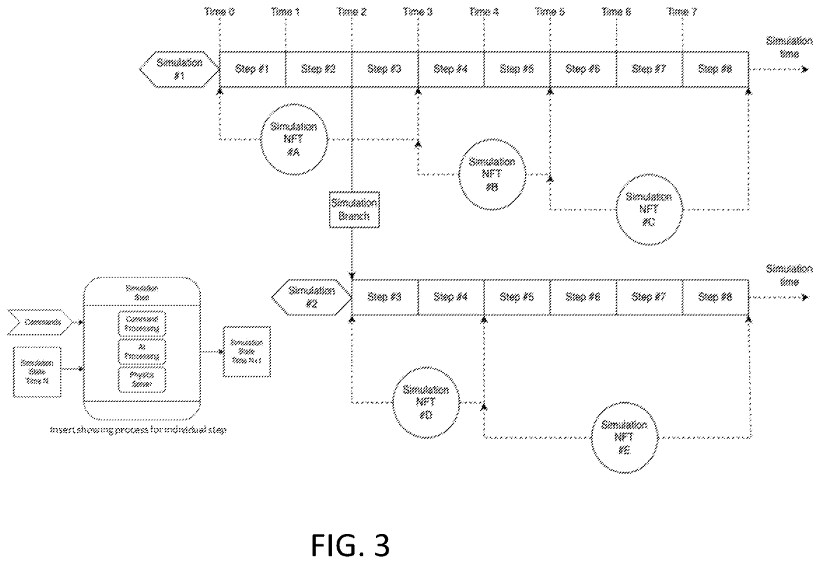

When a user enters a Space they agree to certain ownership conditions set down by the Guardians of that or those Spaces as well as the creator of the Space. As such the creator(s) of the item who helped guide the simulation process are granted discrete ranges of the whole simulation to which they contributed and that is stored within the NFT ledger. When users create something within the Space they can exchange for some nominal fee the right to mint the NFT, thus creating it within the Space and allowing for it to be traded. Creators will control both minting costs for the Space as well as which items they will allow to be minted, giving Creators control of many of the aspects so that Spaces will be correctly curated. Since Users will contribute to the entire Space simulation they might (depending on the conditions of the Space) be due returns when IBP-NFT's within that simulation are traded within the Platform. As such their contribution to the entire Space (see FIG. 3 in the Diagrams section) is recorded within the distributed ledger for calculation on returns. Also, the Guardian(s) of the Space will also receive a percentage of the transaction. This transaction returns value much like a music mechanic or royalty is returned. For every sale the blockchain can trace and calculate the people responsible for the creation and who provided the investment of VM to allow for the original creation and then pay out using the platform token the calculated percentage based on these agreements. Players would directly receive platform tokens and Guardians would exchange platform tokens for IdolNFT's which can then be transferred into their Guardian Wallet. IdolNFT's can then be ‘burned’ and become Cosmic Power NFT's which can be held in Creator Wallets. Cosmic Power NFT's are containers hold different distributions of VM. Creators can transfer the Cosmic Power NFT's out of their Wallets by transferring them into their Spaces, which then insert into the Spaces through various gameplay mechanics in a variety of types with a variety of properties in a distribution as defined by the original Cosmic Power NFT, which is deposited directly into Space's. As such the circular economy of the system is established, and value derived from the creation of IdeaNFT's is able to be translated into respective value throughout the entire system. This entire system where people who have stakes within the simulation as well as the flow of tokens towards Guardians, Creators and Simulation providers, and the associated diffusion of VM and tokens throughout the system, referred to as Token Thermodynamics.

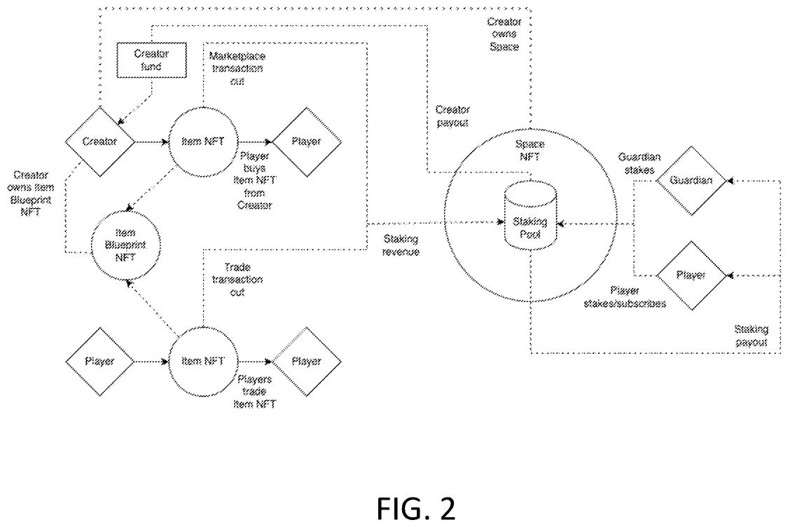

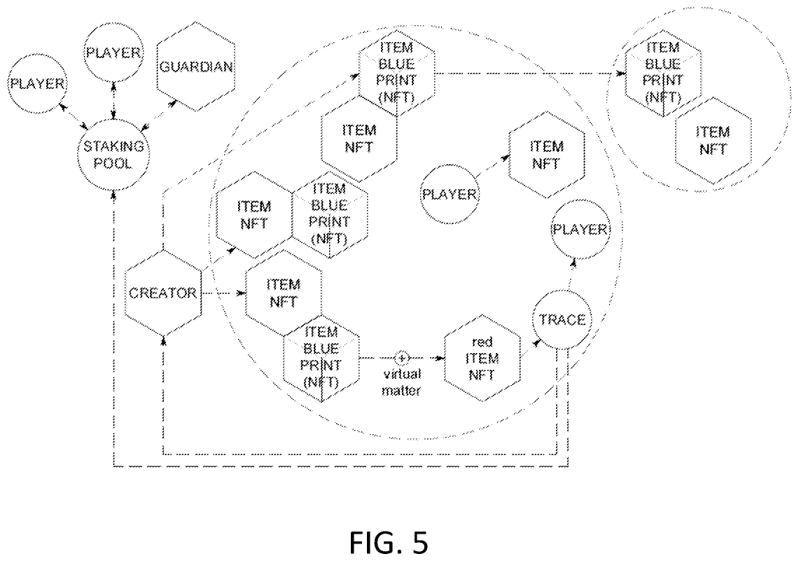

As for growth of the economy this is accomplished via the use of Staking Pools (see FIGS. 2 and 5). Guardians and players can choose to move the platform's tokens (and other materials depending on format, see claim 14) into a staking pool. This will allow them to form a sort of internal DAO where they use the tokens to create IdolNFT's and then Cosmic Powers which can then be used to fund select creators. Creators then accept the Cosmic Powers given to them by the Guardian and invest these NFT's into VM that is inserted into Spaces where the Creator can then use the VM to create new and exciting ItemNFT's. These ItemNFT's of course create a richer environment within the Space encouraging gameplay and interaction for Players, and the Item's IBP-NFT can then be sold by the creator on the marketplace. A certain amount of the revenue from these sales would then be redirected back to the Original Staking Pool, where it can either be re-invested, or will be paid out based on the size of the original Stakes of the Staking Pools Investors from the total remaining in the Staking Pool upon dissolution of the Staking Pool.

### Governance of Spaces and Guardians—Space Staking Model

The economic model according to the present invention shares many of the properties of the previous sections with a few differences highlighted here. The fundamentals of this model are different in that people within the platform do not invest their resources specifically with Guardians or Guardian Staking Pools but directly with Creators by investing directly in the Space. In this way people within the platform directly support areas of their specific interest as opposed to curators of a dimension.

In the economic model, Guardian's still control Dimensions which are areas encompassing Spaces. Guardians aim to collect economic value in two ways. First, they can apply an overall tax to the dimensions, and they will gain a portion of any economic activity within. Also, they can create specific lock-in/lock-out features of the Dimension, which describes the conditions in which a person can move Spaces out of their Dimension. These lock-in/lock-out protocols can encompass any number of different conditions which may or may not be mediated on a smart contract via blockchain protocol. These conditions could include but are not limited to time conditions, pay out conditions, return on investment conditions etc.

In this embodiment the Guardian NFT allows for a Guardians to burn IdolNFT's which are then used to create Cosmic Powers. Cosmic Powers are containers for Virtual Matter which contain a collection of different VM which may or may not relate to specific ‘types’. Types in this sense would be an aesthetic game play mechanic that uses features of the underlying proportions of VM within the Cosmic Power to introduce aesthetic or gameplay properties. In one embodiment a Cosmic Power containing VM of a specific distribution of VM might be of a ‘comet type’. This in-kind means that it is introduction into a Space may be through some gameplay mechanism where a comet strikes the Space and thus injects new VM into the Space. In this mechanism, as before VM is still locked into a Space. The Guardian NFT would also entitle the Guardian to receive occasional ‘drops’ of Cosmic Power that the Platform might use to insert more Cosmic Power into the platform, thus providing an insertion method of additional VM into the overall economy. These Cosmic Powers can then be either bought, traded, or gifted to Creators.

Creators use the Cosmic Power to inject VM into Spaces. Once a Space is established, the Creator can manipulate certain economic flags which can be used to control interest for people wishing the stake with the Space. When users stake Tokens into the Space they essentially can then get a portion of the returns of the economic activity of the Space, both through trading of content, or internal gameplay mechanics/economics deployed by the creator within the Space, and from fee's related to minting new content based NFT's in the Space. These returns will be in proportion to their Staking amount and governed by the other flags set by the Creator. The creator also gets a return from some fraction of the economic activity within the Space as well as gaining IdolNFT drops, where based on a mechanism tied to gameplay, economic activity, and staking amount/members they will gain additional IdolNFT's that they can use to trade for new Cosmic Powers. This is of course in addition the other economic benefits.

In summary the Space should return in some proportion to the following entities:
Guardians through Dimension ‘tax’
Creators through the economic flags set in the Space
Creators of the Space who gain economic return when items they or Players create are ‘minted’ and sold on the platform market.
Stakers in the Space
Players in the Space who gain economic return when items they create are ‘minted’ and sold on the platform market.

### Interfaces Between Spaces

Governance of Spaces is largely run by Guardians who control a dimension of multiple Spaces and selected Space curators (selected by Guardians). While VM cannot be directly transferred between Spaces, IBP-NFT's can if allowed by a Space Curator. Curators will be able to choose which items can be minted in their Spaces, which works bi-directionally. Curators can choose whether an item in their current Space that a player has created can be minted as a new NFT, thus allowing it to be traded on the platform marketplace and they can also decide whether an item that has been minted in the Market place can then be transferred and simulated into existence within an existing Space. This mechanism allows not only for the preservation of VM within a Space, but also allows for Spaces to not be ‘de-valued’ through the introduction of ‘alien’ items that do not match the genre/aesthetic/game mechanics of a specific Space.

### Economy Initialization

The platform economy is initialized with several moving parts needing to act in harmony. Initial seed money is acquired through the use of a standard exchange of fiat money for the platform's cryptocurrency. These tokens can be used within the Platform either for the purchase of IBP-NFT's or for use in Staking Pools. Once initial real world monetary resources are applied then some amount will be applied to begin the simulation of the initial Spaces, and then the economic process as described above can begin.

### Methods of Inflation/Deflation Control

It should be noted that the Platform has a variety of methods of controlling general macroeconomics of the platform. For most systems the largest concern is for the inflation and deflation of the currency. The Platform also must consider the inflation and deflation of its VM as well. As it cost resources to simulate VM it does offer a specific baseline for the value of VM. As such the cost of VM cannot drop far below the value. Participants are encouraged to participate in the economy as described because the true value is found in the created items as opposed to the VM. Hoarding VM in a Space is discouraged due to the cost of needing to run a simulation. VM can be removed by changing the + it leaves Creators wallet as such the platform can exert control over the economic system to maintain health of the platform.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A virtual matter platform whereby content and an AI mediated creation of the content from bespoke virtual matter can take place wherein the area of artificial life as the virtual environment and the intelligent entities contained within it form an ecosystem.

2. The platform according to claim 1 including an ecosystem for use in the platform wherein the virtual matter residing within a creator wallet has value from being readily transferrable into any number of spaces and while still in the wallet, the virtual matter only exists as an item stored within the ecosystem.

3. The platform according to claim 1 wherein the platform facilitates the creation of content, particularly of 3D content as well as methods allowing for the dissemination, re-creation, and leveraging of that content across a variety of user experiences and subsequent derivative content creations.

4. The platform according to claim 1 wherein the platform is a gamified virtual environment integrated with an economic platform.

5. The platform according to claim 1 wherein the platform allows users to generate and create 3D content which are accomplished by robust and broad simulations.

6. The platform according to claim 1 wherein the majority of gameplay interactions are mediated by the virtual matter wherein the virtual matter makes up Spaces and Creatures as fundamental building block.

7. The platform according to claim 1 wherein the platform encompasses a universe of unique ‘Spaces’ each with its own qualities, one of which being its definition of how to process the properties of the virtual matter contained within the universe.

8. The platform according to claim 1 wherein users can create or add to a space by inserting the virtual matter into the space.

9. The platform according to claim 1 wherein the virtual matter can be used to construct artificial life components within the spaces that inhabit and interact with them.

10. The platform according to claim 1 including a progression mechanic having the ability to unlock an item or item feature through gameplay elements wherein the gameplay mechanic can be transferred with the item or item feature.

11. The platform according to claim 1 wherein guardians control dimensions and the Guardians aim to collect economic value by applying an overall tax to the dimensions and gaining a portion of an activity within the platform.

12. The platform according to claim 11 wherein the guardians can create specific lock-in/lock-out features of the dimension, describing the conditions in which a user can move spaces out of their dimension.

13. The platform according to claim 1 wherein a guardian NFT allows for a guardian to burn IdolNFTs, the burnt IdolNFTs used to create Cosmic Powers.

14. An economic model for use in the platform of claim 1 wherein a user can stake directly into a guardian staking pool, the guardian staking pool applying a generated stake to the entire dimensions.

15. The platform according to claim 1 using a method for creating virtual items using the platform with a virtual environment using direct manipulation of virtual matter via a digital avatar controlled by a user.

16. A method for tracking on a distributed ledger system the input of creators and suppliers of materials for creation of digital NFT Items so that royalty based upon the prior mentioned previous agreements can be paid out accordingly during the sale of the NFT.

17. The platform according to claim 1 including a method for transfer of digital matter using the platform of claim 1 that has been registered within a distributed ledger between different simulated environments.

18. The platform according to claim 1 including a method for allowing members of a specified class or multiple classes within the structure of the simulated environment to stake materials (including but not limited to time, computing power, fiat currency, virtual matter, NFT's, tokens, objects created with virtual matter or digital currency etc.) into larger pools and deriving value from those pools that can be applied into the digital platform and the virtual environments contained within.

19. The platform according to claim 1 including a method for the creation of advanced structures via layering of different types of materials to create underlying structures that can scaffold overlying structures utilizing a virtual material.

20. A distributed ledger that containing the steps of a simulation, assigning rights to individuals based on their contribution to the simulation whether through simulation efforts, manipulation efforts, or editing efforts and stores steps so as to be recalled later, also allowing for dispersion of value to appropriate stakeholders based on their contribution.
